(19) United States
(12) Patent Application Publication
(10) Pub. No.: US 2026/0204560 A1
(43) Pub. Date: Jul. 16, 2026

(54) POSITIVE ELECTRODE ACTIVE MATERIAL AND METHOD FOR MANUFACTURING A POSITIVE ELECTRODE ACTIVE MATERIAL

(71) Applicant: Umicore, Brussels (BE)

(72) Inventors: Shinichi KUMAKURA, Olen (BE); JiHoon KANG, Cheonan Chungcheongnam-do (KR); TaeHyeon YANG, Cheonan Chungcheongnam-do (KR); Ji HOON, Cheonan Chungcheongnam-do (KR); GyeongSeo PARK, Cheonan Chungcheongnam-do (KR)

(21) Appl. No.: 19/138,291

(22) PCT Filed: Dec. 14, 2023
(86) PCT No.: PCT/EP2023/085839

§ 371 Date: Jun. 12, 2025

(30) Foreign Application Priority Data
Dec. 16, 2022 (EP) 22214070.9

(51) Int. Cl. H01M 4/525; C01G 53/506; H01M 10/052; H01M 10/0562; H01M 10/0565

(52) U.S. Cl. CPC H01M 4/525; C01G 53/506; H01M 10/052; H01M 10/0562; H01M 10/0565; C01P 2002/54; C01P 2006/40; H01M 2300/0068; H01M 2300/0082

(57) ABSTRACT

The present invention relates a positive electrode active material for solid-state batteries, comprising lithium, oxygen, nickel, and at least one metal selected from the group consisting of manganese and cobalt, wherein the positive electrode active material has an enriched amount of Si in the surface layer, and wherein the positive electrode active material comprises single-crystalline particles. The present inventors have surprisingly found that the positive electrode active material of the invention improves the storage stability of the positive electrode active material. In particular, a decreased uptake of water and carbon (or carbon dioxide) is observed by applying a surface layer of Si on the positive electrode active material. Moreover, the positive electrode active material improves the electrochemical stability of the battery.

### TECHNICAL FIELD

The present invention relates to a positive electrode active material for solid state batteries comprising Li, M′ and O, wherein M′ comprises Si. This invention also relates to a method for manufacturing said positive electrode active material, the solid-state battery comprising said positive electrode active material and the use of said solid-state battery.

### BACKGROUND

As the development of small and lightweight electronic products, electronic devices, communication devices and the like has advanced rapidly and a need for electric vehicles has widely emerged with respect to environmental issues, there is a demand for improvement of performance of secondary batteries used as power sources for these products. Among these, a lithium secondary battery has come into the spotlight as a high-performance battery due to the high energy density and a high reference electrode potential.

During the charging process of a secondary battery, lithium ions are removed from the cathode, transported through the electrolyte and are inserted into the anode while electrons are removed from the cathode and injected into the anode through an external circuit (charger). During the use or discharge of a secondary battery lithium ions are removed from the anode, transported through the electrolyte, and are inserted into the cathode, while electrons flow through an external circuit to provide electric work.

Commonly used cathode active materials are lithium transition metal oxides. During the charging and/or discharging of the lithium battery, the delithiated cathode active material can slowly react with the non-aqueous electrolyte or the solid electrolyte leading to a gradual degradation of the electrochemical performance of lithium batteries using such cathode active materials.

It has been demonstrated that coating of the cathode active material with metals, such as B or Zr, (i.e. applying a thin surface layer of the metal on the cathode active material resulting in an increased amount of said metals in the surface layer) results in a cathode active material exhibiting a higher stability as compared to their counterparts devoid of coating layer.

Doo et al (ACS Appl. Energy Mater. 2019, 2, 6246-6253) contemplates a hydrophobic Ni-rich oxide material obtained after mixing polycrystalline LiNi_{0.8}Co_{0.1}Mn_{0.1} with polydimethylsiloxane followed by heating at 230° C. thereby improving the electrochemical stability of the Ni-rich oxide material.

However, there remains a need to provide a positive electrode active material having an improved storage stability and/or an improved electrochemical stability.

It is an object of the present invention to provide a positive electrode active material comprising Si to improve the storage stability and/or to improve the electrochemical stability of the positive electrode active material.

It is another object of the present invention to provide a method for manufacturing said positive electrode active material.

It is another object of the present invention to provide a battery comprising said positive electrode active material.

It is another object of the present invention to provide a use of said battery.

### SUMMARY OF THE INVENTION

In a first aspect an object of the invention is achieved by providing a positive electrode active material for rechargeable batteries, comprising lithium, oxygen, nickel, and at least one metal selected from the group consisting of manganese and cobalt, wherein the positive electrode active material has an enriched amount of Si in the surface layer, and wherein the positive electrode active material comprises single-crystalline particles.

Worded differently, the positive electrode active material of the invention has a surface layer comprising Si.

The present inventors have surprisingly found that the positive electrode active material of the invention improves the storage stability of the positive electrode active material. In particular, a decreased uptake of water and carbon (or carbon dioxide) is observed by applying a surface layer of Si on the positive electrode active material, as demonstrated in the appended examples. Moreover, the positive electrode active material improves the electrochemical stability of the battery, in particular of a polymer solid-state battery, as indicated by the low Qₜₒₜₐₗ value, which indicates a high stability of the positive electrode active material powder during a high temperature operation. Further, the positive electrode active material improves the efficiency of the battery, in particular of a sulfide solid-state battery.

Without wishing to be bound by any theory, the present inventors believe that the surface layer of Si acts as a hydrophobic surface layer, which suppresses the formation of residual lithium compounds, such as Li₂CO₃, which are formed due to reaction between lithium present in the positive electrode active material and water and carbon in the surrounding air, because the hydrophobic surface inhibits contact between water and the positive electrode active material.

In a further aspect the invention provides a method for manufacturing said positive electrode active material.

In a further aspect the invention provides a battery comprising said positive electrode active material.

In a further aspect the invention provides a use of said battery.

### BRIEF DESCRIPTION OF THE FIGURES

FIG. 1 XPS peak of Si2p for EX2.1

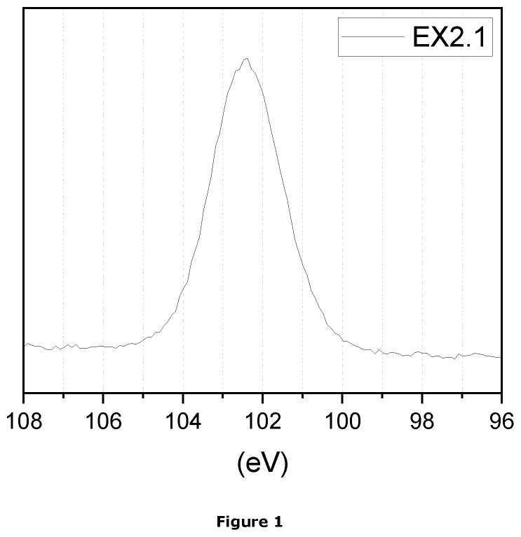

### DETAILED DESCRIPTION OF THE INVENTION

In the following detailed description, preferred embodiments are described in detail to enable practice of the invention. Although the invention is described with reference to these specific preferred embodiments, it will be understood that the invention is not limited to these preferred embodiments. To the contrary, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

The term “solid-state battery” as used herein and in the claims refers to a cell or a battery that includes only solid or substantially solid-state components such as solid electrodes (e.g. anode and cathode) and a solid electrolyte.

The term “a positive electrode active material” (also known as cathode active material) as used herein and in the claims is defined as a material which is electrochemically active in a positive electrode or cathode. By active material, it must be understood to be a material capable to capture and release Li ions when subjected to a voltage change over a predetermined period of time.

The term “a positive electrode” as used herein is defined as a material comprising a positive electrode active material also in addition to other components which are not electrochemically active, in particular conductivity agents such as carbon black or binders such as PVDF.

In the context of the present invention the terms “solid” and “liquid” shall be considered to be a solid and liquid in standard conditions for temperature and pressure as defined by the IUPAC, unless defined otherwise. Hereby the boiling point and the melting point shall be considered to be the boiling point and the melting point at standard atmospheric pressure, i.e. at 101325 Pa.

In the context of the present invention the carbon content and moisture content (or water content) after exposure is measured through an exposure test, conducted by evenly spreading 40 grams of positive electrode active material on a 95×95 mm² dish and place the dish inside a 30° C. chamber. The atmosphere of the chamber is controlled so as to have a relative humidity level of 50%.

### Positive Electrode Active Material

In a first aspect, the present invention concerns a positive electrode active material for solid-state batteries, comprising lithium, oxygen, nickel, and at least one metal selected from the group consisting of manganese and cobalt,
wherein said positive electrode active material further comprises silicon in a content Si_{B},
wherein Si_{B} is expressed as molar fraction Si compared to the sum of molar fractions of Ni, Mn, Co, and Si, as measured by XPS analysis,
wherein Si_{B}>0.05, and
wherein the positive electrode active material comprises single-crystalline particles.

A preferred embodiment is the positive electrode active material of the invention having a carbon content of more than 150 ppm by total weight of the positive electrode active material, preferably a carbon content more than 250 ppm, more preferably a carbon content more than 300 ppm by total weight of the positive electrode active material. A preferred embodiment is the positive electrode active material of the invention having a carbon content of less than 2000 ppm by total weight of the positive electrode active material, preferably a carbon content less than 1850 ppm, more preferably a carbon content less than 1700 ppm, by total weight of the positive electrode active material. A preferred embodiment is the positive electrode active material of the invention having a carbon content in the range of 150 ppm and 2000 ppm by total weight of the positive electrode active material, preferably a carbon content in the range of 250 ppm and 1850 ppm, more preferably a carbon content in the range of 300 ppm and 1700 ppm by total weight of the positive electrode active material. A certain preferred embodiment is the positive electrode active material of the invention having a carbon content of more than 500 ppm by total weight of the positive electrode active material, preferably a carbon content more than 1000 ppm, more preferably a carbon content more than 1200 ppm by total weight of the positive electrode active material. A certain preferred embodiment is the positive electrode active material of the invention having a carbon content of less than 2000 ppm by total weight of the positive electrode active material, preferably a carbon content less than 1850 ppm, more preferably a carbon content less than 1700 ppm, by total weight of the positive electrode active material. A certain preferred embodiment is the positive electrode active material of the invention having a carbon content in the range of 500 ppm and 2000 ppm by total weight of the positive electrode active material, preferably a carbon content in the range of 1000 ppm and 1850 ppm, more preferably a carbon content in the range of 1200 ppm and 1700 ppm by total weight of the positive electrode active material. Further, the above reported carbon content of the positive electrode active material of the invention is measured before the exposure test. As appreciated by the skilled person the carbon content of the positive electrode active material of the invention is measured with a carbon analyzer. For example, but not limiting to the invention, a Horiba Emia-Expert carbon/sulfur analyzer can be used to measure the carbon content.

In a preferred embodiment of the invention the positive electrode active material of the invention has a carbon uptake of less than 1500 ppm carbon by total weight of the positive electrode active material, preferably a carbon uptake of less than 1200 ppm carbon, more preferably a carbon uptake of less than 1000 ppm carbon by total weight of the positive electrode active material. As appreciated by the skilled person the carbon uptake is measured after the exposure test.

A preferred embodiment is the positive electrode active material of the invention having a water content of more than 10 ppm by total weight of the positive electrode active material, preferably a water content more than 25 ppm, more preferably a water content more than 50 ppm by total weight of the positive electrode active material. A preferred embodiment is the positive electrode active material of the invention having a water content of less than 1200 ppm by total weight of the positive electrode active material, preferably a water content less than 1000 ppm, more preferably a water content less than 500 ppm, by total weight of the positive electrode active material. A preferred embodiment is the positive electrode active material of the invention having a water content in the range of 10 ppm and 1200 ppm by total weight of the positive electrode active material, preferably a water content in the range of 25 ppm and 1000 ppm, more preferably a water content in the range of 50 ppm and 500 ppm by total weight of the positive electrode active material. As appreciated by the skilled person the water or moisture content is measured by Karl Metrohm Fischer Coulometer. Further, the above reported water content of the positive electrode active material of the invention is measured before the exposure test.

In a preferred embodiment of the invention the positive electrode active material of the invention has a water uptake of less than 1500 ppm water by total weight of the positive electrode active material, preferably a water uptake of less than 1000 ppm water, more preferably a water uptake of less than 500 ppm water by total weight of the positive electrode active material. As appreciated by the skilled person the water uptake is measured after the exposure test.

A preferred embodiment is the positive electrode active material of the invention comprising Li, Ni, Mn, Co and oxygen, wherein Ni is in a content x, wherein 50.0≤x≤98.0 mol %, relative to the sum of Ni, Mn and Co. A more preferred embodiment is the positive electrode active material of the invention, wherein Ni is in a content x≥55.0 mol %, preferably x≥58.0 mol %, more preferably x≥60.0 mol %, relative to the sum of Ni, Mn and Co. In a preferred embodiment Ni is in a content x≤90.0 mol % preferably x≤88 mol %, more preferably x≤85.0 mol %, relative to the sum of Ni, Mn and Co. A more preferred embodiment is the positive electrode active material of the invention, wherein Ni is in a content x between 55.0 mol %≤x≤90.0 mol %, preferably 58.0 mol %≤x≤88.0 mol %, more preferably 60.0 mol %≤x≤85.0 mol %, relative to the sum of Ni, Mn and Co.

A certain preferred embodiment is the positive electrode active material of the invention comprising Li, Ni, Mn, Co and oxygen, wherein M′ comprises Ni is in a content x≥55.0 mol %, preferably x≥58.0 mol %, more preferably x≥60.0 mol %, relative to the sum of Ni, Mn and Co. In a certain preferred embodiment Ni is in a content x≤75.0 mol % preferably x≤72 mol %, more preferably x≤70.0 mol %, relative to the sum of Ni, Mn and Co. A more certain preferred embodiment is the positive electrode active material of the invention, wherein Ni is in a content x between 55.0 mol %≤x≤75.0 mol %, preferably 58.0 mol %≤x≤72.0 mol %, more preferably 60.0 mol %≤x≤70.0 mol %, relative to the sum of Ni, Mn and Co.

A certain preferred embodiment is the positive electrode active material of the invention comprising Li, Ni, Mn, Co and oxygen, wherein Ni is in a content x≥75.0 mol %, preferably x≥78.0 mol %, more preferably x≥80.0 mol %, relative to the sum of Ni, Mn and Co. In a certain preferred embodiment Ni is in a content x≤92.0 mol % preferably x≤90 mol % and more preferably x≤88.0 mol %, relative to the sum of Ni, Mn and Co. A more certain preferred embodiment is the positive electrode active material of the invention, wherein Ni is in a content x between 75.0 mol %≤x≤92.0 mol %, preferably 78.0 mol %≤x≤90.0 mol %, more preferably 80.0 mol %≤x≤88.0 mol %, relative to the sum of Ni, Mn and Co.

A preferred embodiment is the positive electrode active material of the invention comprising Li, Ni, Mn, Co and oxygen, wherein Mn is in a content y, wherein 0.0≤y≤30.0 mol %, relative to the sum of Ni, Mn and Co. A more preferred embodiment is the positive electrode active material of the invention, wherein Mn is in a content y>0.0 mol %, preferably y≥1.0 mol %, more preferably y≥2.0 mol %, relative to the sum of Ni, Mn and Co. In a more preferred embodiment the content is y≤20.0 mol %, preferably y≤15.0 mol %, and more preferably y≤10.0 mol %, relative to the sum of Ni, Mn and Co. In a more preferred embodiment Mn is in a content 0.0 mol %<y≤20.0 mol %, preferably 1.0 mol %≤y≤15.0 mol %, more preferably 2.0 mol %≤y≤10.0 mol %, relative to the sum of Ni, Mn and Co.

A certain preferred embodiment is the positive electrode active material of the invention comprising Li, Ni, Mn, Co and oxygen, wherein Mn is in a content y>0.0 mol %, preferably y≥5.0 mol %, more preferably y≥10.0 mol %, relative to the sum of Ni, Mn and Co. In a certain preferred embodiment the content is y≤30.0 mol %, preferably y≤25.0 mol %, and more preferably y≤20.0 mol %, relative to the sum of Ni, Mn and Co. In a certain preferred embodiment Mn is in a content 0.0 mol %<y≤30.0 mol %, preferably 5.0 mol %≤y≤25.0 mol %, more preferably 10.0 mol %≤y≤20.0 mol %, relative to the sum of Ni, Mn and Co.

A preferred embodiment is the positive electrode active material of the invention comprising Li, Ni, Mn, Co and oxygen, wherein Co is in a content z, wherein 0.0≤z≤30.0 mol %, relative to the sum of Ni, Mn and Co. In a more preferred embodiment Co is in a content z>0.0 mol %, preferably z≥1.0 mol %, more preferably z≥2.0 mol %, relative to the sum of Ni, Mn and Co. In a preferred embodiment the content is z≤20.0 mol %, preferably z≤15.0 mol %, and more preferably z≤10.0 mol %, relative to the sum of Ni, Mn and Co. In a preferred embodiment Co is in a content 0.0 mol %<z≤20.0 mol %, preferably 1.0 mol %≤z≤15.0 mol %, more preferably 2.0 mol %≤z≤10.0 mol %, relative to the sum of Ni, Mn and Co.

A certain preferred embodiment is the positive electrode active material of the invention comprising Li, Ni, Mn, Co and oxygen, wherein Co is in a content z>0.0 mol %, preferably z≥5.0 mol %, more preferably z≥10.0 mol %, relative to the sum of Ni, Mn and Co. In a preferred embodiment the content is z≤30.0 mol %, preferably z≤25.0 mol %, and more preferably z≤20.0 mol %, relative to the sum of Ni, Mn and Co. In a preferred embodiment Co is in a content 0.0 mol %<z≤30.0 mol %, preferably 5.0 mol %≤z≤25.0 mol %, more preferably 10.0 mol %≤z≤20.0 mol %, relative to the sum of Ni, Mn and Co.

A highly preferred embodiment is the positive electrode active material of the invention comprising Li, Ni, Mn, Co and oxygen, wherein:
Ni in a content x, wherein 50.0≤x≤98.0 mol %, relative to the sum of Ni, Mn and Co,
Mn in a content y, wherein 0.0≤y≤30.0 mol %, relative to the sum of Ni, Mn and Co,
Co in a content z, wherein 0.0≤z≤30.0 mol %, relative to the sum of Ni, Mn and Co, and
wherein x, y and z are measured by ICP-OES.

As appreciated by the skilled person the amount of Li, Ni, Mn and Co in the positive electrode active material is measured by Inductively Coupled Plasma Optical Emission Spectroscopy (ICP-OES). For example, but not limiting to the invention, an Agilent ICP 720-ES is used in the ICP-OES analysis.

A more highly preferred embodiment is the positive electrode active material of the invention comprising Li, M′, and oxygen, wherein M′ comprises:
Ni in a content x between 55.0 mol %≤x≤90.0 mol %, preferably 58.0 mol %≤x≤88.0 mol %, more preferably 60.0 mol %≤x≤85.0 mol %, relative to the sum of Ni, Mn and Co.
Mn in a content 0.0 mol %<y≤20.0 mol %, preferably 1.0 mol %≤y≤15.0 mol %, more preferably 2.0 mol %≤y≤10.0 mol %, relative to the sum of Ni, Mn and Co,
Co in a content 0.0 mol %<z≤20.0 mol %, preferably 1.0 mol %≤z≤15.0 mol %, more preferably 2.0 mol %≤z≤10.0 mol %, relative to the sum of Ni, Mn and Co, and
wherein x, y and z are measured by ICP-OES.
   A highly preferred embodiment is the positive electrode active material of the invention, comprising Li, M′, and oxygen, wherein M′ comprises:
Ni in a content x′, wherein 50.0≤x′≤98.0 mol %, relative to M′,
Mn in a content y′, wherein 0.0≤y′≤30.0 mol %, relative to M′,
Co in a content z′, wherein 0.0≤z′≤30.0 mol %, relative to M′,
Si in a content a′, wherein 0.0<a′≤5.0 mol %, relative to M′,
D in a content d′, wherein D is an element other than Li, Ni, Mn, Co, Si and oxygen; wherein 0.0≤d′≤2.0 mol %, relative to M′,
wherein x′, y′, z′, a′ and d′ are measured by ICP-OES, and
wherein x′+y′+z′+a′+d′ is 100.0 mol %.

As appreciated by the skilled person the amount of Li and M′, preferably Li, Ni, Mn, Co, D and Si, in the positive electrode active material is measured by Inductively Coupled Plasma Optical Emission Spectroscopy (ICP-OES). For example, but not limiting to the invention, an Agilent ICP 720-ES is used in the ICP-OES analysis.

A more preferred embodiment is the positive electrode active material of the invention, comprising Li, M′, and oxygen, wherein M′ comprises Ni in a content x′≥55.0 mol %, preferably x′≥58.0 mol %, more preferably x′≥60.0 mol %, relative to M′. In a preferred embodiment Ni is in a content x′≤90.0 mol % preferably x′≤88 mol %, more preferably x′≤85.0 mol %, relative to M′. A more preferred embodiment is the positive electrode active material of the invention, wherein Ni is in a content x′ between 55.0 mol %≤x′≤90.0 mol %, preferably 58.0 mol %≤x′≤88.0 mol %, more preferably 60.0 mol %≤x′≤85.0 mol %, relative to M′.

A certain preferred embodiment is the positive electrode active material of the invention comprising Li, M′, and oxygen, wherein M′ comprises Ni is in a content x′≥55.0 mol %, preferably x′≥58.0 mol %, more preferably x′≥60.0 mol %, relative to M′. In a certain preferred embodiment Ni is in a content x′≤75.0 mol % preferably x′≤72 mol %, more preferably x′≤70.0 mol %, relative to M′. A more certain preferred embodiment is the positive electrode active material of the invention, wherein Ni is in a content x′ between 55.0 mol %≤x′≤75.0 mol %, preferably 58.0 mol %≤x′≤72.0 mol %, more preferably 60.0 mol %≤x′≤70.0 mol %, relative to M′.

A certain preferred embodiment is the positive electrode active material of the invention comprising Li, M′, and oxygen, wherein M′ comprises Ni in a content x′≥75.0 mol %, preferably x′≥78.0 mol %, more preferably x′≥80.0 mol %, relative to M′. In a certain preferred embodiment Ni is in a content x′≤92.0 mol % preferably x′≤90 mol % and more preferably x′≤88.0 mol %, relative to M′. A more certain preferred embodiment is the positive electrode active material of the invention, wherein Ni is in a content x between 75.0 mol %≤x′≤92.0 mol %, preferably 78.0 mol %≤x′≤90.0 mol %, more preferably 80.0 mol %≤x′≤88.0 mol %, relative to M′.

A more preferred embodiment is the positive electrode active material of the invention, comprising Li, M′, and oxygen, wherein M′ comprises Mn in a content y′>0.0 mol %, preferably y′≥1.0 mol %, more preferably y′≥2.0 mol %, relative to M′. In a more preferred embodiment the content is y′≤20.0 mol %, preferably y′≤15.0 mol %, and more preferably y′≤10.0 mol %, relative to M′. In a more preferred embodiment Mn is in a content 0.0 mol %<y′≤20.0 mol %, preferably 1.0 mol %≤y′≤15.0 mol %, more preferably 2.0 mol %≤y′≤10.0 mol %, relative to M′.

A certain preferred embodiment is the positive electrode active material of the invention comprising Li, M′, and oxygen, wherein M′ comprises Mn in a content y′>0.0 mol %, preferably y′≥5.0 mol %, more preferably y′≥10.0 mol %, relative to M′. In a certain preferred embodiment the content is y′≤30.0 mol %, preferably y′≤25.0 mol %, and more preferably y′≤20.0 mol %, relative to M′. In a certain preferred embodiment Mn is in a content 0.0 mol %<y′≤30.0 mol %, preferably 5.0 mol %≤y′≤25.0 mol %, more preferably 10.0 mol %≤y′≤20.0 mol %, relative to M′.

In a more preferred embodiment is the positive electrode active material of the invention comprising Li, M′, and oxygen, wherein M′ comprises Co in a content z′>0.0 mol %, preferably z′≥1.0 mol %, more preferably z′≥2.0 mol %, relative to M′. In a preferred embodiment the content is z′≤20.0 mol %, preferably z′≤15.0 mol %, and more preferably z′≤10.0 mol %, relative to M′. In a preferred embodiment Co is in a content 0.0 mol %<z′≤20.0 mol %, preferably 1.0 mol %≤z′≤15.0 mol %, more preferably 2.0 mol %≤z′≤10.0 mol %, relative to M′.

A certain preferred embodiment is the positive electrode active material of the invention comprising Li, M′, and oxygen, wherein M′ comprises Co in a content z′>0.0 mol %, preferably z′≥5.0 mol %, more preferably z′≥10.0 mol %, relative to M′. In a preferred embodiment the content is z′≤30.0 mol %, preferably z′≤25.0 mol %, and more preferably z′≤20.0 mol %, relative to M′. In a preferred embodiment Co is in a content 0.0 mol %<z′≤30.0 mol %, preferably 5.0 mol %≤z′≤25.0 mol %, more preferably 10.0 mol %≤z′≤20.0 mol %, relative to M′.

As is known to the skilled person, the positive electrode active material of the invention can comprise impurities or be doped or coated resulting in an overall positive electrode active material comprising one or more elements other than Li, Ni, Mn, Co, Si and O, which is reflected in the parameter “D” used herein. A preferred embodiment is the positive electrode active material according to the invention comprising D, wherein D is at least one element selected from the group consisting of Al, B, Ba, Ca, Ce, Cr, Fe, La, Mg, Mo, Nb, S, Sr, Ti, V, W, Y, Zr and Zn; preferably Al, B, Ti, Cr, Nb, S, Y, and W; more preferably Al, B, Ti, Nb, and W.

A preferred embodiment is the positive electrode active material according to the invention comprising Li, M′, and oxygen, wherein M′ comprises D in a content d′>0.0 mol %, preferably d′≥0.25 mol %, more preferably d′≥0.5 mol %, relative M′. In a preferred embodiment the content d′≤1.75 mol %, preferably d′≤1.5 mol %, more preferably d′≤1.25 mol %, relative to M′. In a preferred embodiment the content d is 0.0 mol %<d′≤1.75 mol %, preferably 0.25 mol %≤d′≤1.5 mol %, more preferably 0.5 mol %≤d′≤1.25 mol %, relative to M′.

In certain preferred embodiments the positive electrode active material is according to the invention, wherein d′=0.0 mol %, relative to M′.

A preferred embodiment is the positive electrode active material according to the invention comprising Li, M′, and oxygen, wherein M′ comprises Si in a content a′>0.01 mol %, preferably a′≥0.05 mol %, more preferably a′≥0.1 mol %, relative M′. In a preferred embodiment the content a′≤2.0 mol %, preferably a′≤1.0 mol %, more preferably a′≤0.8 mol %, relative to M′. In a preferred embodiment the content a is 0.01 mol %<a′≤2.0 mol %, preferably 0.05 mol %≤a′≤1.0 mol %, more preferably 0.1 mol %≤a′≤0.8 mol %, relative to M′.

A preferred embodiment is the positive electrode active material of the invention having a Li/M′ ratio, preferably a Li/(Ni+Mn+Co) ratio, >0.90, preferably >0.92, more preferably >0.95. A preferred embodiment is the positive electrode active material of the invention having a Li/M′ ratio, preferably a Li/(Ni+Mn+Co) ratio, <1.10, preferably <1.08, more preferably <1.05. A preferred embodiment is the positive electrode active material of the invention having a Li/M′ ratio, preferably a Li/(Ni+Mn+Co) ratio, in the range of 0.90-1.10, preferably in the range of 0.92-1.08, more preferably in the range of 0.95-1.05. As appreciated by the skilled person the Li/M′ ratio, preferably the Li/(Ni+Mn+Co) ratio, is a molar ratio (mol/mol).

A highly preferred embodiment is the positive electrode active material according to the invention having a formula (I):

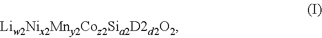

wherein 0.90≤w2≤1.10, preferably 0.92≤w2≤1.08, more preferably 0.95≤w2≤1.05;
, wherein 0.55≤x2≤0.90, preferably 0.58≤x2≤0.88, more preferably 0.60≤x2≤0.85;
, wherein 0.0<y2≤0.30, preferably 0.05≤y2≤0.25, more preferably 0.10≤y2≤0.20;
, wherein 0.0<z2≤0.30, preferably 0.05≤z2≤0.25, more preferably 0.10≤z2≤0.20;
, wherein 0.0001≤a2≤0.02, preferably 0.0005≤a2≤0.01, more preferably 0.0001≤a2≤0.008;
wherein 0.0≤d2≤0.0175, preferably 0.0≤d2≤0.015, more preferably 0.0≤d2≤0.0125, most preferably d2 is about 0.0;
wherein x2+y2+z2+a2+b2+d2=1.00; and
wherein D2 is an element other than Li, O, Ni, Co, Mn and Si.

In certain preferred embodiment 0.55≤x2≤0.75, preferably 0.58≤x2≤0.72, more preferably 0.60≤x2≤0.70;

As is known to the skilled person, the positive electrode active material of the invention can comprise impurities or be doped or coated resulting in an overall positive electrode active material comprising one or more elements other than Li, Ni, Mn, Co, Si and O, which is reflected in the parameter “D2” used herein. A preferred embodiment is the positive electrode active material according to the invention comprising D2, wherein D2 is at least one element selected from the group consisting of Al, B, Ba, Ca, Ce, Cr, Fe, La, Mg, Mo, Nb, S, Sr, Ti, V, W, Y, Zr and Zn; preferably Al, B, Ti, Cr, Nb, S, Y, and W; more preferably Al, B, Ti, Nb, and W.

### Surface Layer

The present invention provides the positive electrode active material according to the invention, wherein said positive electrode active material comprises silicon in a content Si_{B}, wherein Si_{B} is expressed as molar fraction Si compared to the sum of molar fractions of Ni, Mn, Co, and Si, as measured by XPS analysis, wherein Si_{B}>0.05.

In a preferred embodiment the positive electrode active material is according to the invention, wherein Si_{B}>0.1, preferably Si_{B}>0.15, more preferably Si_{B}>0.2. In a preferred embodiment Si_{B}<5.0, preferably Si_{B}<2.0, more preferably Si_{B}<1.0. In a preferred embodiment Si_{B} is in the range of 0.1 and 5.0, preferably Si_{B} is in the range of 0.15 and 2.0, more preferably Si_{B} is in the range of 0.2 and 1.0.

In a certain preferred embodiment the positive electrode active material is according to the invention, wherein Si_{B}>0.35, preferably Si_{B}>0.5, more preferably Si_{B}>0.8. In a preferred embodiment Si_{B}<5.0, preferably Si_{B}<2.0, more preferably Si_{B}<1.0. In a preferred embodiment Si_{B} is in the range of 0.35 and 5.0, preferably Si_{B} is in the range of 0.50 and 2.0, more preferably Si_{B} is in the range of 0.80 and 1.0.

In a certain preferred embodiment the positive electrode active material is according to the invention, wherein Si_{B}>0.1, preferably Si_{B}>0.15, more preferably Si_{B}>0.2. In a certain preferred embodiment Si_{B}<1.0, preferably Si_{B}<0.98, more preferably Si_{B}<0.9. In a preferred embodiment Si_{B} is in the range of 0.1 and 1.0, preferably Si_{B} is in the range of 0.15 and 0.98, more preferably Si_{B} is in the range of 0.2 and 0.9.

In a certain preferred embodiment the positive electrode active material is according to the invention, wherein Si_{B}>0.35, preferably Si_{B}>0.5, more preferably Si_{B}>0.8. In a preferred embodiment Si_{B}<1.0, preferably Si_{B}<0.98, more preferably Si_{B}<0.9. In a preferred embodiment Si_{B} is in the range of 0.35 and 1.0, preferably Si_{B} is in the range of 0.50 and 0.98, more preferably Si_{B} is in the range of 0.80 and 0.98.

In a certain preferred embodiment the positive electrode active material is according to the invention, wherein Si_{B}>0.1, preferably Si_{B}>0.15, more preferably Si_{B}>0.2. In a preferred embodiment Si_{B}<1.0, preferably Si_{B}<0.5, more preferably Si_{B}<0.4. In a preferred embodiment Si_{B} is in the range of 0.1 and 1.0, preferably Si_{B} is in the range of 0.15 and 0.5, more preferably Si_{B} is in the range of 0.2 and 0.4.

In an embodiment the positive electrode active material is according to the invention, wherein said positive electrode active material further comprises silicon in a content Si_{C}, wherein Si_{C} is expressed as molar fraction Si compared to the sum of molar fractions of Ni, Mn and Co, as measured by XPS analysis, wherein Si_{C}>0.05.

In a preferred embodiment the positive electrode active material is according to the invention, wherein Si_{C}>0.10, preferably Si_{C}>0.15, more preferably Si_{C}>0.20. In a preferred embodiment Si_{C}<50.0, preferably Si_{C}<15.0, more preferably Si_{C}<1.0. In a preferred embodiment Si_{C} is in the range of 0.10 and 50.0, preferably Si_{C} is in the range of 0.15 and 15.0, more preferably Si_{C} is in the range of 0.20 and 1.0.

In a certain preferred embodiment, the positive electrode active material is according to the invention, wherein Si_{C}>1.0, preferably Si_{C}>5.0, more preferably Si_{C}>10.0. In a preferred embodiment Si_{C}<50.0, preferably Si_{C}<40.0, more preferably Si_{C}<30.0. In a preferred embodiment Si_{C} is in the range of 1.0 and 50.0, preferably Si_{C} is in the range of 5.0 and 40.0, more preferably Si_{B} is in the range of 10.0 and 30.0.

In a preferred embodiment the positive electrode active material is according to the invention, wherein the positive electrode active material has a Si content Si_{A} defined as a′/(x′+y′+z′+a′), wherein the positive electrode active material has a Si content Si_{B}, wherein Si_{B} is expressed as molar fraction Si compared to the sum of molar fractions of Ni, Mn, Co, Si, and Zr, as measured by XPS analysis, wherein the ratio Si_{B}/Si_{A}>5.0.

In a preferred embodiment the positive electrode active material is according to the invention, wherein the ratio Si_{B}/Si_{A}>10.0, preferably wherein the ratio Si_{B}/Si_{A}>15.0, more preferably wherein the ratio Si_{B}/Si_{A}>20.0. In a preferred embodiment the positive electrode active material is according to the invention, wherein the ratio Si_{B}/Si_{A}<1000.0, preferably wherein the ratio Si_{B}/Si_{A}<500.0, more preferably wherein the ratio Si_{B}/Si_{A}<100.0. In a preferred embodiment the positive electrode active material is according to the invention, wherein the ratio Si_{B}/Si_{A} is in the range of 10.0 and 1000.0, preferably wherein the ratio Si_{B}/Si_{A} is in the range of 15.0 and 500.0, more preferably wherein the ratio Si_{B}/Si_{A} is in the range of 20.0 and 100.0.

In a certain preferred embodiment, the positive electrode active material is according to the invention, wherein the ratio Si_{B}/Si_{A}>80.0. In a certain preferred embodiment, the positive electrode active material is according to the invention, wherein the ratio Si_{B}/Si_{A}<120.0. In a certain preferred embodiment, the positive electrode active material is according to the invention, wherein the ratio Si_{B}/Si_{A} is in the range of 80.0 and 120.0.

In the context of the present invention, Si_{B} or Si_{C} is the molar fraction of Si measured in a region of a particle of the positive electrode active material according to invention defined between a first point of an external edge of said particle and a second point at a distance from said first point. Said distance separating said first to said second point being equal to a penetration depth of said XPS, said penetration depth D′ being comprised between 1.0 to 10.0 nm. In particular, the penetration depth is the distance along an axis perpendicular to a virtual line tangent to said external edge and passing trough said first point.

The external edge of the particle is, in the framework of this invention, the boundary or external limit distinguishing the particle from its external environment. Therefore, XPS analysis provides atomic content of elements in an uppermost layer of a particle with a penetration 30 depth of about 10.0 nm from an outer boundary of the particle. The outer boundary of the particle is also referred to as “surface”. For example, but not limiting to the invention, XPS analysis is carried out with a Thermo K-α+ spectrometer (Thermo Scientific). In the framework of the present invention, at % signifies atomic percentage. The at % or “atomic percent” of a given element expression of a concentration means how many percent of all atoms in the concerned compound are atoms of said element. Further in the framework of the present invention the designation at % is equivalent to mol % or “molar percent”.

As appreciated by the skilled person the defined ratio Si_{B}/Si_{A} refers to the positive electrode active material of the invention having an enriched amount of Si in the surface layer of the positive electrode active material. The surface layer of the positive electrode active material is 1 to 10 nm of the uppermost part of the positive electrode active material. Worded differently, the positive electrode active material of the invention comprises a surface layer of Si. For example, but not limiting to the invention, a compound of Si present in the surface layer of the positive electrode active material is Li₂SiO₃.

In the context of the present invention the positive electrode active material may comprise a first surface layer comprising D, wherein D is at least one element selected from the group consisting of Al, B, Ba, Ca, Ce, Cr, Fe, La, Mg, Mo, Nb, S, Sr, Ti, V, W, Y, Zr and Zn; preferably Al, B, Ti, Cr, Nb, S, Y, and W; more preferably Al, B, Ti, Nb, and W, wherein the surface layer of Si may be placed on the first surface layer and/or the first surface layer may be placed on the surface layer of Si and/or the positive electrode active layer may comprise a mixed surface layer comprising the surface layer of Si and the first surface layer.

A certain preferred embodiment concerns the positive electrode active material according to the invention, wherein the positive electrode active material has
a Si content Si_{B} in the range of 0.10 and 5.0, preferably Si_{B} is in the range of 0.15 and 2.0, more preferably Si_{B} is in the range of 0.20 and 1.0; and
a Si content Si_{C} in the range of 0.10 and 50.0, preferably Si_{C} is in the range of 0.15 and 15.0, more preferably Si_{C} is in the range of 0.20 and 1.0.

A certain more preferred embodiment concerns the positive electrode active material according to the invention, wherein the positive electrode active material has
a Si content Si_{B} in the range of 0.35 and 5.0, preferably Si_{B} is in the range of 0.50 and 2.0, more preferably Si_{B} is in the range of 0.80 and 1.0; and
a Si content Si_{C} in the range of 1.0 and 50.0, preferably Si_{C} is in the range of 5.0 and 40.0, more preferably Si_{B} is in the range of 10.0 and 30.0.

A certain preferred embodiment concerns the positive electrode active material according to the invention, wherein the positive electrode active material has
a Si content Si_{B} in the range of 0.10 and 5.0, preferably Si_{B} is in the range of 0.15 and 2.0, more preferably Si_{B} is in the range of 0.20 and 1.0; and
the ratio Si_{B}/Si_{A} in the range of 10.0 and 1000.0, preferably wherein the ratio Si_{B}/Si_{A} is in the range of 15.0 and 500.0, more preferably wherein the ratio Si_{B}/Si_{A} is in the range of 20.0 and 100.0.

A certain more preferred embodiment concerns the positive electrode active material according to the invention, wherein the positive electrode active material has
a Si content Si_{B} in the range of 0.35 and 5.0, preferably Si_{B} is in the range of 0.50 and 2.0, more preferably Si_{B} is in the range of 0.80 and 1.0; and
the ratio Si_{B}/Si_{A} is in the range of 80.0 and 120.0.

A certain preferred embodiment concerns the positive electrode active material according to the invention, wherein the positive electrode active material has
a Si content Si_{B} in the range of 0.10 and 5.0, preferably Si_{B} is in the range of 0.15 and 2.0, more preferably Si_{B} is in the range of 0.20 and 1.0;
a Si content Si_{C} in the range of 0.10 and 50.0, preferably Si_{C} is in the range of 0.15 and 15.0, more preferably Si_{C} is in the range of 0.20 and 1.0; and
the ratio Si_{B}/Si_{A} in the range of 10.0 and 1000.0, preferably wherein the ratio Si_{B}/Si_{A} is in the range of 15.0 and 500.0, more preferably wherein the ratio Si_{B}/Si_{A} is in the range of 20.0 and 100.0.

A certain more preferred embodiment concerns the positive electrode active material according to the invention, wherein the positive electrode active material has
a Si content Si_{B} in the range of 0.35 and 5.0, preferably Si_{B} is in the range of 0.50 and 2.0, more preferably Si_{B} is in the range of 0.80 and 1.0;
a Si content Si_{C} in the range of 1.0 and 50.0, preferably Si_{C} is in the range of 5.0 and 40.0, more preferably Si_{B} is in the range of 10.0 and 30.0; and
the ratio Si_{B}/Si_{A} is in the range of 80.0 and 120.0.

In a preferred embodiment the particles have a Co content Co_{edge} as measured by cross-sectional EDS (CS-EDS) at an edge of the particles, wherein Co_{edge} is expressed as mol % relative to the sum of Ni, Mn, and Co content as measured by CS-EDS at the edge of the particles, wherein the particles have a Co content Co_{center} as measured by CS-EDS at a center of the particle, wherein Co_{center} is expressed as mol % relative to the sum of Ni, Mn, and Co content as measured by CS-EDS at the center of the particles, and wherein the ratio CO_{edge}/CO_{center}>1.10, preferably CO_{edge}/CO_{center}>1.20, more preferably Co_{edge}/CO_{center}>1.30, most preferably Co_{edge}/CO_{center}>1.50.

In a preferred embodiment the particles have an Al content Al_{A} defined as c/(x+y+z+c), wherein c is the content of Al as measured by XPS, and wherein the positive electrode active material has a Al content Al_{B}, wherein Al_{B} is determined by XPS analysis, wherein Al_{B} is expressed as a molar fraction compared to the sum of molar fractions of Co, Mn, Ni and Al as measured by XPS analysis, wherein the ratio Al_{B}/Al_{A}>1.0, preferably the ratio Al_{B}/Al_{A}>2.0, more preferably the ratio Al_{B}/Al_{A}>2.5, even more preferably 25 the ratio Al_{B}/Al_{A}>3.0, even more preferably the ratio Al_{B}/Al_{A}>3.5, most preferably the ratio Al_{B}/Al_{A}>4.0.

### Morphology

The present invention provides the positive electrode active material according to the invention, wherein said positive electrode active material comprises single-crystalline particles.

In the context of the present invention a particle is considered to be single-crystalline if it consists of only one grain or at most five grains, preferably at most three grains, as observed by Scanning Electron Microscope (SEM) or Transmission Electron Microscope (TEM), preferably by observing grain boundaries of the particle. A grain boundary is defined as the interface between two grains in a particle, preferably wherein the atomic planes of the two grains are aligned to different orientations and meet as a crystalline discontinuity.

In certain preferred embodiments of the invention and in the context of the present invention the single-crystalline particle as defined herein is a monolithic particle. As appreciated by the skilled person in these certain preferred embodiments all embodiments related to the single-crystalline particle equally apply to the monolithic particle as defined in the present invention.

As appreciated by the skilled person a polycrystalline particle is agglomerated by 5 or more single-crystalline particles, preferably 10 or more single-crystalline particles, more preferably 50 or more single-crystalline particles. This can be observed in proper microscope techniques like Scanning Electron Microscope (SEM) by observing grain boundaries. Agglomeration of the single-crystalline particles to the polycrystalline particles occurs under a post-treatment step such as a thermal treatment step.

Certain preferred embodiments concern the positive electrode active material of the invention comprising single-crystalline particles having a primary particle median D50 value of less than 15 μm, preferably less than 10 μm, more preferably less than 5 μm. Certain preferred embodiments concern the positive electrode active material of the invention comprising single-crystalline particles having a primary particle median D50 value of more than 1 μm, preferably more than 2 μm, more preferably more than 3 μm. Certain preferred embodiments concern the positive electrode active material of the invention comprising single-crystalline particles having a primary particle median D50 value between 1 and 15 μm, preferably between 2 and 10 μm, more preferably between 3 and 5 μm. As appreciated by the skilled person the particle size distribution (PSD) D50 of the positive electrode active material powder is measured by laser diffraction particle size analysis. Preferably, the D50 is defined as a volume average particle size, more preferably the particle size at 50% of the cumulative volume % distributions obtained from the Malvern Mastersizer 3000 with Hydro MV measurements. For example, but not limiting to the invention, the particle median D50 can be measured using a Malvern Mastersizer 3000.

As appreciated by the skilled person said single-crystalline particles have said content Si_{A}, Si_{B}, Si_{C} and their corresponding ratios.

In certain preferred embodiments the present invention provides the positive electrode active material according to the invention, wherein said positive electrode active material is a powder comprising single particles and/or secondary particles, wherein each of the single particles consist of only one primary particle and each of the secondary particles consist of at least two primary particles and at most twenty primary particles as observed in a SEM image.

Preferably, at least 30% of the particles, more preferably at least 50% of the particles, constituting the powder observed in a SEM image are the single particles and/or the secondary particles. The number of primary particles constituting the single particles and/or the secondary particles are determined in a field of view of at least 45 μm×at least 60 μm (i.e. of at least 2700 μm²), preferably of: at least 100 μm×100 μm (i.e. of at least 10,000 μm².

The particles in the image should be well distributed therefore avoiding overlap between particles. This can be achieved by pouring a small amount of powder sample to the adhesive attached on the SEM sample holder and blowing air to remove the excess powder.

In the context of the present invention primary particles are distinguished from each other in a SEM image by observing grain boundaries between the primary particles. A grain boundary is defined as the interface between two primary particles, preferably wherein the atomic planes of the two primary particles are aligned to different orientations and meet as a crystalline discontinuity.

As appreciated by the skilled person the polycrystalline particles are agglomerated by more than 20 primary particles, preferably 50 or more primary particles, more preferably 100 or more primary particles. Hence, in certain preferred embodiments said positive electrode active material is a powder comprising polycrystalline particles, wherein each of the polycrystalline particles consist of more than 20 primary particles, preferably 50 or more primary particles, more preferably 100 or more primary particle as observed in a SEM image.

Preferably, at least 30% of the particles, more preferably at least 50% of the particles, constituting the powder observed in a SEM image are polycrystalline particles. The number of primary particles constituting the polycrystalline particles are determined in a field of view of at least 45 μm×at least 60 μm (i.e. of at least 2700 μm²), preferably of: at least 100 μm×100 μm (i.e. of at least 10,000 μm². The particles in the image should be well distributed therefore avoiding overlap between particles. This can be achieved by pouring a small amount of powder sample to the adhesive attached on the SEM sample holder and blowing air to remove the excess powder.

In a further aspect the invention provides a single-crystalline particles-based positive electrode active material for solid state batteries comprising lithium, oxygen, nickel, and at least one metal selected from the group consisting of manganese and cobalt,
wherein said positive electrode active material further comprises silicon in a content Si_{B}, wherein Si_{B} is expressed as molar fraction Si compared to the sum of molar fractions of Ni, Mn, Co, and Si, as measured by XPS analysis,
wherein Si_{B}>0.05.

In a highly preferred embodiment of the single-crystalline particles-based positive electrode active material, all embodiments directed to the positive electrode active material according to the first aspect of the invention apply mutatis mutandis to the single-crystalline particles-based positive electrode active material. For example, the various embodiments relating to the identity and amounts of Li, M′, Si_{C}, Si_{B}, Si_{A} and carbon content as explained herein in the context of the positive electrode active material are equally applicable to the single-crystalline particles-based positive electrode active material.

### Method

In a second aspect the invention provides a method for manufacturing a positive electrode active material, wherein said method comprises:
step a) mixing a lithium transition metal-based oxide compound with a source of silicon, and
step b) heating the mixture under an oxidizing atmosphere in a furnace at a temperature under 500° C. for a time between 1 hour and 20 hours so as to obtain the positive electrode active material.

In a highly preferred embodiment of the method for manufacturing a positive electrode active material of the invention the positive electrode active material is according to the first aspect of the invention. As appreciated by the skilled person, in case the method for manufacturing a positive electrode active material of the invention affords the positive electrode material according to the first aspect of the invention, all embodiments directed to the positive electrode active material according to the first aspect of the invention apply mutatis mutandis to the method for manufacturing the positive electrode active material according to the first aspect of the invention. For example, the various embodiments relating to the identity and amounts of Li, M′, Si_{C}, Si_{B}, Si_{A} and carbon content as explained herein in the context of the positive electrode active material are equally applicable to the method for the preparation of the positive electrode active material.

In a preferred embodiment of the method the lithium transition metal-based oxide compound comprising Li, M″ and oxygen, wherein M″ comprises Ni, Mn, Co and D, wherein D is at least one element of the group consisting of: Al, B, Ba, Ca, Ce, Cr, Fe, La, Mg, Mo, Nb, S, Sr, Ti, V, W, Y, Zr and Zn; preferably Al, B, Ti, Cr, Nb, S, Y, and W; more preferably Al, B, Ti, Nb, and W. Preferably, the lithium transition metal-based oxide used is also typically prepared according to a lithiation process, which is the process wherein a mixture of a transition metal oxide precursor and a further source of lithium is heated at a temperature preferably of at least 500° C. and at most 1000° C. Typically, the transition metal precursor is prepared by coprecipitation of one or more transition metal sources, such as salts, preferably sulfates or nitrates, more preferably sulfates; of the elements Ni, Mn and/or Co, in the presence of an alkali compound, such as an alkali hydroxide e.g. sodium hydroxide and/or ammonia. Preferably, the further source of lithium is metallic lithium or a lithium salt, preferably a lithium salt such as LiOH.

In a preferred embodiment of the method, the source of Si is a Si-alkoxide, an alkylalkoxy silane or a polysiloxane, preferably an alkylalkoxy silane or a polysiloxane.

In a preferred embodiment of the method the source of Si is a Si-alkoxide, preferably SiOR¹R²R³R⁴, wherein R¹, R², R³ and R⁴ are independently selected from H and C₁-C₈alkyl or alkenyl optionally substituted with a halide, preferably C₁-C₄ alkyl, more preferably C₁-C₂ alkyl. In a more preferred embodiment of the method, the source of Si is a Si-alkoxide being SiOR₄⁵, wherein R⁵ is a C₁-C₈alkyl or alkenyl optionally substituted with a halide, preferably a C₁-C₄ alkyl, more preferably a C₁-C₂ alkyl. In a highly preferred the source of Si is silicon tetraethoxide.

In a highly preferred embodiment of the method the source of Si is an alkylalkoxy silane, more preferably R⁶ₐ(R⁷O)_{b}Si with a=, 1, 2 or 3, b=1, 2 or 3, a+b=4, and R⁶ and R⁷ independently selected from the group consisting of H and C₁-C₈alkyl or alkenyl optionally substituted with a halide, preferably a C₁-C₄ alkyl, more preferably a C₁-C₂ alkyl; more preferably R¹ and R² are the same alkyl group selected from the group consisting of a C₁-C₈ alkyl or alkenyl optionally substituted with a halide, preferably a C₁-C₄ alkyl, more preferably a C₁-C₂ alkyl; most preferably the source of Si is methyltrimethoxy silane.

In a highly preferred embodiment, the source of Si is a polysiloxane, preferably a polydialkylsiloxane, wherein the alkyl is selected from C₁-C₈alkyl or alkenyl optionally substituted with a halide, preferably C₁-C₄ alkyl, more preferably C₁-C₂ alkyl; more preferably a polydimethylsiloxane. In a highly preferred embodiment, the source of Si is polysiloxane being a hydroxy terminated polydimethylsiloxane or a trimethylsiloxy terminated polydimethylsiloxane, preferably a hydroxy terminated polydimethylsiloxane. The present invention is not limited to a particular polydimethylsiloxane having a specific number average molecular weight Mₙ. Such polymers are commercially available in a variety of different number average molecular weight. Preferably, the hydroxy terminated polydimethylsiloxane or the trimethylsiloxy terminated polydimethylsiloxane has a number average molecular weight Mₙ between 200 g/mol and 1 000 000 g/mol, preferably between 300 g/mol and 150 000 g/mol, most preferably between 400 g/mol and 10 000 g/mol, such as about 410 g/mol or 4200 g/mol.

In a certain preferred embodiment, the mixing the lithium transition metal-based oxide compound with the source of silicon, in particular when the source of Si is a polysiloxane as defined in the present invention, occurs through dry-mixing of said lithium transition metal-based oxide compound with said source of silicon. As appreciated by the skilled person dry-mixing means that no additional solvent is added to the mixture of the lithium transition metal-based oxide compound and the source of silicon.

In a certain preferred embodiment of the method the source of silicon is added to a first liquid, in particular when the source of silicon is the alkylalkoxy silane as defined in the present invention, preferably the source of silicon is dissolved in the first liquid. Preferably the first liquid is water. Preferably, the lithium transition metal-based oxide compound with the source of silicon added to the first liquid is further mixed with a second liquid, preferably the second liquid comprises water and an alcohol, more preferably the second liquid is a mixture of water and an alcohol. Preferably, the alcohol is methanol, ethanol, propanol, butanol or a mixture thereof, preferably methanol or ethanol, more preferably ethanol. In a preferred embodiment the weight ratio of alcohol to water (meaning the overall content of water present in the first liquid and the second liquid) is between 10:1 and 1:10, preferably between 5:1 and 1:5, more preferably 2:1 and 1:2. The present inventors believe that by adding water to the source of silicon being the alkylalkoxy silane as defined in the present invention, the alkylalkoxy silane is hydrolyzed to the corresponding polyalkylsiloxane through a polycondensation reaction, which is then coated on the positive electrode active material of the present invention through the heating step b).

In a preferred embodiment the Si content in the source of silicon is at least 0.05 wt. %, relative to the total weight of the positive electrode active material, preferably at least 0.1 wt. %, more preferably at least 0.15 wt. % relative to the total weight of the positive electrode active material. In a preferred embodiment the Si content in the source of silicon is at most 1.0 wt. %, relative to the total weight of the positive electrode active material, preferably at most 0.5 wt. %, more preferably at most 0.1 wt. % relative to the total weight of the positive electrode active material. In a preferred embodiment the Si content in the source of silicon is in the range of 0.05 and 1.0 wt. %, relative to the total weight of the positive electrode active material, preferably in the range of 0.1 and 0.5 wt. %, more preferably in the range of 0.15 and 0.1 wt. % relative to the total weight of the positive electrode active material.

In a preferred embodiment of the method is the heating of the mixture at a temperature of at least 25° C., preferably at least 50° C., more preferably at least 65° C. In a preferred embodiment of the method is the heating of the mixture at a temperature of at most 450° C., preferably at most 400° C., more preferably at most 350° C. In a preferred embodiment of the method is the heating of the mixture at a temperature of between 25° C. and 450° C., preferably between 50° C. and 400° C., more preferably between 65° C. and 350° C.

In a preferred embodiment of the method is the heating of the mixture of at least 2 hours, preferably at least 3 hours, more preferably at least 4 hours. In a preferred embodiment of the method is the heating of the mixture of at most 15 hours, preferably at most 10 hours, more preferably at most 7 hours. In a preferred embodiment of the method is the heating of the mixture between 2 hours and 15 hours, preferably between 3 hours and 10 hours, more preferably between 4 hours and 7 hours.

In a more preferred embodiment of the method is the heating of the mixture
at a temperature between 25° C. and 450° C., preferably between 50° C. and 400° C., more preferably between 65° C. and 350° C.; and
at a time between 2 hours and 15 hours, preferably between 3 hours and 10 hours, more preferably between 4 hours and 7 hours.

A preferred embodiment of the method is the heating of the mixture under an oxidizing atmosphere. Preferably, the oxidizing atmosphere comprises oxygen, such as air, or consists of oxygen.

In a more preferred embodiment, the heating of the mixture occurs under an oxidizing atmosphere in a furnace.

### Product-by-Process

In a third aspect the invention concerns the positive electrode active material obtainable by the method according to the second aspect of the invention. As appreciated by the skilled person all embodiments directed to the positive electrode active material according to the first aspect of the invention and/or the method according to the second aspect of the invention apply mutatis mutandis to the positive electrode active obtainable by the method according to the invention. For example, the various embodiments relating to the identity and amounts of Li, M′, Si_{C}, Si_{A}, Si_{B} and the source of silicon as explained herein in the context of the positive electrode active material or the method for manufacturing said positive electrode active material are equally applicable to the positive electrode active material obtainable by the method for the preparation of the positive electrode active material.

### Battery

In a fourth aspect the invention concerns a battery comprising the positive electrode active material according to the first aspect of the invention and/or the positive electrode active material obtainable by the method according to the third aspect of the invention.

In a preferred embodiment the battery is a solid-state battery.

In a certain preferred embodiment, the solid-state battery comprises a sulfide-based electrolyte. Preferably said electrolyte is a sulfide based solid electrolyte, more preferably the electrolyte comprises Li, P, and S. Typically, the following sulfur containing compounds of Li₆PS₅X with X being F, Cl, Br or I; preferably X is Cl or Br, thio-LISICON (Li_{3.25}Ge_{0.25}P_{0.75}S₄), Li₂S—P₂S₅—LiCl, Li₂S—SiS₂, LiI—Li₂S—SiS₂, Li₂S—P₂S₅—LiCl, Li₂S—SiS₂, LiI—Li₂S—SiS₂, LiI—Li₂S—P₂S₅, LiI—Li₂SP₂O₅, LiI—Li₃PO₄—P₂S₅, Li₂S—P₂S₅, Li₃PS₄, Li₂P₃S₁₁, LiI—Li₂S—B₂S₃, Li₃PO₄—Li₂S—SiS₂, Li₃PO₄—Li₂S—SiS₂, Li₃PO₄—Li₂S—SiS₂, Li₁₀GeP₂S₁₂, Li_{9.54}Si_{1.74}P_{1.44}S_{11.7}Cl_{0.3}, and/or Li₂P₃S₁₁ may be suitably used. In a highly preferred embodiment, the battery is a sulfide solid-state battery.

In a certain preferred embodiment, the solid-state battery comprises a polymer-based electrolyte, preferably a polymer-based solid electrolyte, more preferably the polymer-based solid electrolyte is polymer comprising oxyethylene units, most preferably the polymer-based solid electrolyte is polyethylene oxide. The present invention is not limited to a particular polyethylene oxide having a specific weight average molecular weight M_{w}. Such polymers are commercially available in a variety of different number average molecular weight. Preferably the polyethylene oxide has a weight average molecular weight M_{w} of less than 5 000 000 g/mol and more than 50 000 g/mol, preferably a weight average molecular weight M_{w} of less than 3 000 000 g/mol and more than 100 000 g/mol, more preferably a weight average molecular weight M_{w} of less than 2 000 000 g/mol and more than 500 000 g/mol, most preferably a weight average molecular weight M_{w} of about 1 000 000 g/mol. In a highly preferred embodiment, the battery is a polymer solid-state battery.

Preferably, the solid-state battery further comprises an anode comprising anode active material. Suitable electrochemically active anode materials are those known in the art. For example, the anode may comprise graphitic carbon, metallic lithium or a metal alloy comprising lithium, such as Li—In alloy, as the anode active material.

In a preferred embodiment the battery according to the invention, preferably the solid-state battery comprising the sulfide-based electrolyte as defined herein, has an efficiency of at least 85%, preferably at least 86%, more preferably at least 87%, most preferably at least 88%. As appreciated by the skilled person the efficiency of the battery is determined, wherein the initial charge capacity (CQ1) and discharge capacity (DQ1) are measured in constant current mode (CC) at C rate of 0.1 C in voltage range from 4.3 V to 2.5 V (Li/Li⁺) or from 3.7 V to 1.9 V (In—Li/Li⁺). The efficiency (%) of the reversible capacity is obtained according to an equation below:

$$Efficiency ( \% ) = \frac{DQ 1}{CQ 1} \times 100 ( \% ) .$$

Preferably, the schedule uses a 1 C current definition of 160 mA/g.

A preferred embodiment concers the battery according to the invention, preferably the solid-state battery comprising the polymer-based electrolyte as defined herein, having a Qₜₒₜₐₗ of less than 70 mAh/g, preferably less than 65 mAh/g, more preferably less than 50 mAh/g, most preferably less than 45 mAh/g. As appreciated by the skilled person the Qₜₒₜₐₗ is defined susing the following coin cell testing procedure with a a 1 C current definition of 160 mA/g in the 4.4-3.0 V/Li metal window range:
Step 1) Charging in a constant current mode with C-rate of 0.05 with an end condition of 4.4 V followed by 10 minutes rest.
Step 2) Discharging in a constant current mode with C-rate of 0.05 with an end condition of 3.0 V followed by 10 minutes rest. Discharge capacity of this step is DQ1.
Step 3) Charging in a constant current mode with C-rate of 0.05 with an end condition of 4.4 V.
Step 4) Switching to a constant voltage mode and keeping 4.4 V for 60 hours.
Step 5) Discharging in a constant current mode with C-rate of 0.05 with an end condition of 3.0 V. Discharge capacity of this step is DQ2, wherein Qₜₒₜₐₗ is defined as the total leaked capacity at the high voltage and high temperature in the Step 4).

### Use

In a fifth aspect the present invention concerns a use of the positive electrode active material according to the first aspect of the invention and/or the positive electrode active material obtainable by the method according to the third aspect of the invention in a battery.

A preferred embodiment is the use of the positive electrode active material in a battery, preferably a solid-state-battery, more preferably a sulfide solid-state-battery, to increase the efficiency of said battery.

A preferred embodiment is the use of the positive electrode active material in a battery, preferably a solid-state-battery, more preferably a polymer solid-state-battery, to decrease the Qₜₒₜₐₗ of said battery.

In a sixth aspect the present invention concerns a use of the battery according to invention in either one of a portable computer, a tablet, a mobile phone, an energy storage system, an electric vehicle or in a hybrid electric vehicle, preferably in an electric vehicle or in a hybrid electric vehicle.

### EXAMPLES

The following analysis methods are used in the Examples:

### A) Inductively Coupled Plasma-Optical Emission Analysis (ICP-OES)

The contents of the elements in positive electrode active material examples and comparative example as described herein below are measured by the Inductively Coupled Plasma-Optical Emission Spectrometry (ICP-OES) method using an Agillent ICP 720-OES. 1 gram of a powder sample is dissolved into 50 mL high purity hydrochloric acid in an Erlenmeyer flask. The flask is covered by a watch glass and heated on a hot plate at 380° C. until complete dissolution of the sample. After being cooled to room temperature, the solution and the rinsing water of Erlenmeyer flask are transferred to a 250 mL volumetric flask. Afterwards, the volumetric flask is filled with DI water up to the 250 mL mark, followed by complete homogenization. An appropriate amount of solution is taken out by pipette and transferred into a 250 ml volumetric flask for the 2^{nd} dilution, where the volumetric flask is filled with internal standard and 10% hydrochloric acid up to the 250 mL mark and then homogenized. Finally, this solution is used for ICP-OES measurement. The contents of Ni, Mn, Co, and Si are expressed as wt. % of the total of these contents. Another suitable solvent can be used to fully dissolve the positive electrode active material powder samples.

### B) Particle Size

The PSD is measured using a Malvern Mastersizer 3000 with Hydro MV wet dispersion accessory after dispersing examples as described herein below of positive electrode active material powders in an aqueous medium. To improve the dispersion of the positive electrode active material powder examples, sufficient ultrasonic irradiation and stirring is applied, and an appropriate surfactant is introduced. D50 is defined as the particle size at 50% of the cumulative volume % distribution.

### C) Polymer Cell Test

### C1) Polymer Cell Preparation

### C1.1) Solid Polymer Electrolyte (SPE) Preparation

A solid polymer electrolyte (SPE) is prepared according to the process as follows:
Step 1) Mixing polyethylene oxide (PEO, 1,000,000 g/mol, Alfa Aesar) with lithium bis(trifluoromethanesulfonyl)imide salt (LiTFSI, >98.0%, TCI) in acetonitrile anhydrous 99.8 wt % (Aldrich), using a mixer for 30 minutes at 2,000 revolutions per minute (rpm). The mass ratio of polyethylene oxide to LiTFSI is 3.0.
Step 2) Pouring the mixture from Step 1) into a Teflon dish and drying at 25° C. for 12 hours.
Step 3) Detaching the dried SPE from the dish and punching the dried SPE in order to obtain SPE disks having a thickness of 300 μm and a diameter of 19 mm.

### C1.2) Positive Electrode Preparation

A positive electrode is prepared according to the process as follows:
Step 1) Preparing a polymer electrolyte mixture comprising polyethylene oxide (PEO, 100,000 g/mol, Alfa Aesar) solution in anisole anhydrous 99.7 wt % (Sigma-Aldrich) and Lithium bis(trifluoromethanesulfonyl)imide salt (LiTFSI, >98.0%, TCI) in acetonitrile. The mixture has a ratio of PEO:LiTFSI of 74:26 by weight.
Step 2) Mixing the polymer electrolyte mixture prepared from Step 1) with a positive electrode active material and a conductor powder (Super P, Timcal) in acetonitrile solution with a ratio of 21:75:4 by weight so as to prepare a slurry mixture. The mixing is performed by a homogenizer for 45 minutes at 5,000 rpm.
Step 3) Casting the slurry mixture from Step 2) on one side of a 20 μm-thick aluminum foil with 100 μm coater gap.
Step 4) Drying the slurry-casted foil at 30° C. for 12 hours followed by punching in order to obtain catholyte electrodes having a diameter of 14 mm.

### C1.3) Negative Electrode Preparation

A Li foil (diameter 16 mm, thickness 500 μm) is prepared as a negative electrode.

### C1.4) Polymer Cell Assembling

The coin-type polymer cell is assembled in an argon-filled glovebox with an order from bottom to top: a 2032 coin cell can, a positive electrode prepared from section C1.2, a SPE prepared from section C1.1, a gasket, a negative electrode prepared from section C1.3, a spacer, a wave spring, and a cell cap. Then, the coin cell is completely sealed to prevent leakage of the electrolyte.

### C2) Testing Method

Each coin-type polymer cell is cycled at 80° C. using a Toscat-3100 computer-controlled galvanostatic cycling stations (Toyo). The coin cell testing procedure uses a 1 C current definition of 160 mA/g in the 4.4-3.0 V/Li metal window range according to the schedule below:
Step 1) Charging in a constant current mode with C-rate of 0.05 with an end condition of 4.4 V followed by 10 minutes rest.
Step 2) Discharging in a constant current mode with C-rate of 0.05 with an end condition of 3.0 V followed by 10 minutes rest. Discharge capacity of this step is DQ1.
Step 3) Charging in a constant current mode with C-rate of 0.05 with an end condition of 4.4 V.
Step 4) Switching to a constant voltage mode and keeping 4.4 V for 60 hours.
Step 5) Discharging in a constant current mode with C-rate of 0.05 with an end condition of 3.0 V. Discharge capacity of this step is DQ2.

Qₜₒₜₐₗ is defined as the total leaked capacity at the high voltage and high temperature in the Step 4) according to the described testing method. A low value of Qₜₒₜₐₗ indicates a high stability of the positive electrode active material powder during a high temperature operation.

### D) Sulfide Cell Test

### D1) Sulfide Cell Preparation

### D1.1) Positive Electrode Preparation:

For the preparation of a positive electrode, a slurry contains positive electrode active material powder, Li—P—S based solid electrolyte, carbon (Super-P, Timcal), and binder (RC-10, Arkema)—with a formulation of 64.0:30.0:3.0:3.0 by weight—in butyl acetate solvent is mixed in Ar-filled glove box. The slurry is casted on one side of an aluminum foil followed by drying the slurry coated foil in a vacuum oven to obtain a positive electrode. The obtained positive electrode is punched with a diameter of 10 nm wherein the active material loading amount is around 4 mg/cm².

### D1.2) Negative Electrode Preparation:

For the preparation of a negative electrode, Li foil (diameter 3 mm, thickness 100 μm) is placed centered on the top of In foil (diameter 10 nm, thickness 100 μm) and pressed to form Li—In alloy negative electrode.

### D1.3) Separator Preparation:

For the preparation of a separator which also has a function of the solid electrolyte in a battery, the Li—P—S based solid electrolyte is pelletized with a pressure of 250 MPa to obtain 100 μm pellet thickness.

### D1.4) Cell Assembly:

A sulfide solid-state rechargeable battery is assembled in an Ar-filled glovebox with such order from bottom to top: positive electrode comprising Al current collector with the coated part on the top—separator—negative electrode with Li side on the top—Cu current collector. The stacked components are pressed together with a pressure of 250 MPa and placed in an external cage to prevent air exposure.

### D2) Testing Method

The testing method is a conventional “constant cut-off voltage” test. Each cell is cycled at 60° C. using a Toscat-3100 computer-controlled galvanostatic cycling station (from Toyo).

The schedule uses a 1 C current definition of 160 mA/g. The initial charge capacity (CQ1) and discharge capacity (DQ1) are measured in constant current mode (CC) at C rate of 0.1 C in voltage range from 4.3 V to 2.5 V (Li/Li⁺) or from 3.7 V to 1.9 V (In—Li/Li⁺). The efficiency (%) of the reversible capacity is obtained according to an equation below:

$$Efficiency ( \% ) = \frac{DQ 1}{CQ 1} \times 100 ( \% ) .$$

### E) Exposure Test

The carbon and moisture exposure test is conducted by evenly spreading 40 grams of positive electrode active material on a 95×95 mm² dish and place the dish inside a 30° C. chamber. The atmosphere of the chamber is controlled so as to have a relative humidity level of 50%. After 3 days (72 hours), the positive electrode active material powder is taken for the carbon analysis as described in method E and moisture analysis in method F.

### F) Carbon Analysis

The content of carbon of the positive electrode active material powder is measured by Horiba Emia-Expert carbon/sulfur analyzer. 1 gram of the positive electrode active material powder is placed in a ceramic crucible in a high frequency induction furnace. 1.5 grams of tungsten and 0.2 grams of tin are added into the crucible as accelerators. The powder is heated at a programmable temperature wherein gases produced during the combustion are then analyzed by Infrared detectors. The analysis of CO₂ and CO determines the carbon concentration.

### G) Moisture Analysis

The moisture content of the positive electrode active material powder is measured by Karl Metrohm Fischer Coulometer. 1 gram of the positive electrode active material powder is placed in the 200° C. KF furnace under N₂ atmosphere. The evaporated moistures is guided into the KF reactor and is analyzed by KF coulometry.

### H) X-Ray Photoelectron Spectroscopy (XPS)

In the present invention, X-ray photoelectron spectroscopy (XPS) is used to analyze the surface of positive electrode active material powder particles. In XPS measurement, the signal is acquired from the first few nanometers (e.g., 1 nm to 10 nm) of the uppermost part of a sample, i.e., surface layer. Therefore, all elements measured by XPS are contained in the surface layer.

For the surface analysis of positive electrode active material powder particles, XPS measurement is carried out using a Thermo K-α+ spectrometer. Monochromatic Al Kα radiation (hu=1486.6 eV) is used with a spot size of 400 μm and measurement angle of 45°. A wide survey scan to identify elements present at the surface is conducted at 200 eV pass energy. C1s peak having a maximum intensity (or centered) at a binding energy of 284.8 eV is used as a calibrate peak position after data collection. Accurate narrow scans are performed afterwards at 50 eV for at least 10 scans for each identified element to determine the precise surface composition.

Curve fitting is done with CasaXPS Version2.3.19PR1.0 using a Shirley-type background treatment and Scofield sensitivity factors. The fitting parameters are according to Table 2a. Line shape GL(30) is the Gaussian/Lorentzian product formula with 70% Gaussian line and 30% Lorentzian line. LA(α, β, m) is an asymmetric line-shape where α and β define tail spreading of the peak and m define the width.

TABLE 1a
XPS fitting parameter for Ni2p3, Mn2p3, Co2p3, and Si1p.

| | Sensitivity | Fitting range | | |
|---|---|---|---|---|
| Element | factor | (eV) | Defined peak(s) | Line shape |
| Ni | 14.61 | 851.3 ± 0.1- | Ni2p3, Ni2p3 | LA(1.33, |
| | | 869.4 ± 0.1 | satellite | 2.44, 69) |
| Mn | 9.17 | 639.9 ± 0.1- | Mn2p3, Mn2p3 | GL(30) |
| | | 649.5 ± 0.1 | satellite | |
| Co | 12.62 | 775.8 ± 0.2- | Co2p3 peak 1, | GL(30) |
| | | 792.3 ± 0.3 | Co2p3 peak 2, | |
| | | | Co2p3 satellite | |
| Si | 0.817 | 97.5 ± 0.1- | Si2p | GL(30) |
| | | 106.3 ± 0.1 | | |

For Co peak, constraints are set for each defined peak according to Table 1b.

TABLE 1b
XPS fitting constraints for Co2p peak fitting.

| | | Fitting range | FWHM | |
|---|---|---|---|---|
| Element | Defined peak | (eV) | (eV) | Area |
| Co | Co2p3 peak 1 | 776.0-780.9 | 0.5-4.0 | No constraint set |
| | Co2p3 peak 2 | 781.0-785.0 | 0.5-4.0 | No constraint set |
| | Co2p3 satellite | 786.2-792.0 | 0.5-4.0 | No constraint set |

The Si surface contents as determined by XPS are expressed as atomic fractions of Si, respectively, in the surface layer of the particles divided by the total content of Ni, Mn, Co, and/or Si in said surface layer. It is calculated as follows:

$$atomic ratio of Si to Ni , Mn , Co , and Si by XPS = {Si}_{B} = \frac{Si ( at . \% )}{Ni + Mn + Co + Si ( at . \% )}$$

$$atomic ratio of Si to Ni , Mn , and Co by XPS = {Si}_{C} = \frac{Si ( at . \% )}{Ni + Mn + Co ( at . \% )}$$

The present invention is further illustrated in the following examples:

### Comparative Example 1

A single-crystalline positive electrode active material labelled as CEX1 was prepared according to the following steps:
Step 1) Transition metal oxidized hydroxide precursor preparation: A nickel-based transition metal oxidized hydroxide powder (TMH1) having a metal composition Ni_{0.85}Mn_{0.07}Cl_{0.08} was prepared by a co-precipitation process in a large-scale continuous stirred tank reactor (CSTR) with mixed nickel manganese cobalt sulfates, sodium hydroxide, and ammonia.
Step 2) Precursor oxidation: the TMH1 prepared from Step 1) was heated at 400° C. for 7 hours in an oxidizing atmosphere to obtain a heated product.
Step 3) First mixing: the heated product prepared from Step 2) was mixed with LiOH in an industrial blender to obtain a first mixture having a lithium to metal (Ni, Mn, and Co) ratio of 0.96.
Step 4) First heating: The first mixture from Step 3) was heated at 890° C. for 11 hours in an oxidizing atmosphere to obtain a first heated product.
Step 5) Wet bead milling: The first heated product from Step 4) was bead milled in a solution containing 0.5 mol % Co with respect to the total molar contents of Ni, Mn, and Co in the first heated product followed by drying and sieving process to obtain a milled product. The bead milling solid to solution weight ratio was 6:4 and was conducted for 20 minutes.
Step 6) Second mixing: the milled product obtained from Step 5) was mixed in an industrial blender with 1.5 mol % Co from Co₃O₄ and 7.5 mol % Li from LiOH, each with respect to the total molar contents of Ni, Mn, and Co in the milled product to obtain a second mixture.
Step 7) Second heating: The second mixture from Step 6) was heated at 760° C. for 10 hours in an oxidizing atmosphere followed by crushing and sieving with 250 ppm of alumina powder to obtain CEX1 comprising Ni, Mn, and Co in a ratio Ni:Mn:Co of 0.84:0.07:0.09 as obtained by ICP-OES. CEX1 has a D50 of 4 μm.

Due to the wet milling in step 5) CEX1 is a single-crystalline powder (i.e. a powder comprising single particles and/or secondary particles, wherein each of the single particles consist of only one primary particle and each of the secondary particles consist of at least two primary particles and at most twenty primary particles).

### Example 1

EX1.1 was prepared by mixing CEX1 with 2000 ppm of Si from polydimethylsiloxane trimethylsiloxy terminated (PDMS-C) in an industrial blender followed by heating at 75° C. for 6 h under a flow of oxygen gas. PDMS-C is a liquid with molecular weight of around 410 g/mol.

EX1.2 was prepared according to the same method as EX1.1, except that the heating temperature is 150° C.

EX1.3 was prepared according to the same method as EX1.1, except that the heating temperature is 300° C.

### Example 2

EX2.1 was prepared by mixing CEX1 with 2000 ppm of Si from polydimethylsiloxane hydroxy terminated (PDMS-O) in an industrial blender followed by heating at 75° C. for 6 hours under a flow of oxygen gas. PDMS-O is a liquid with molecular weight of around 4200 g/mol.

EX2.2 was prepared according to the same method as EX2.1, except that the heating temperature is 150° C.

EX2.3 was prepared according to the same method as EX2.1, except that the heating temperature is 300° C.

### Comparative Example 2

A poly-crystalline positive electrode active material labelled as CEX2.1 was prepared according to the following steps:
Step 1) Mixing: the TMH1 prepared from Step 1) of CEX1 was mixed with LiOH in an industrial blender to obtain a first mixture having a lithium to metal (Ni, Mn, and Co) ratio of 0.98.
Step 2) Heating: The first mixture from Step 1) was heated at 785° C. for 10 hours in an oxidizing atmosphere to obtain CEX2 comprising Ni, Mn, and Co in a ratio Ni:Mn:Co of 0.85:0.07:0.08 as obtained by ICP-OES. CEX1 has a D50 of 4 μm.
CEX2.2 was prepared by mixing CEX2.1 with 2000 ppm of Si from PDMS-C in an industrial blender followed by heating at 75° C. for 6 h under a flow of oxygen gas.
CEX2.3 was prepared according to the same method as CEX2.2, except that the heating temperature is 150° C.
CEX2.4 was prepared according to the same method as CEX2.2, except that the heating temperature is 300° C.

### Comparative Example 3

CEX3.1 was prepared by mixing CEX2.1 with 2000 ppm of Si from PDMS-O in an industrial blender followed by heating at 75° C. for 6 hours under a flow of oxygen gas.

CEX3.2 was prepared according to the same method as EX2.1, except that the heating temperature is 150° C.

CEX3.3 was prepared according to the same method as EX2.1, except that the heating temperature is 300° C.

### Example 3

EX3.1 was prepared according to below steps:
Step 1) Mixing: mix 300 grams of CEX1 with 2.97 grams of methyltrimethoxysilane (CH₃Si(OCH₃)₃) in an industrial blender
Step 2) Heating: heating the mixture prepared from Step 1) at 350° C. for 6 hours under a flow of oxygen gas to produce EX3.1 having 2000 ppm of Si.

EX3.2 was prepared according to below steps:
Step 1) Methyltrimethoxysilane solution preparation: mixing 2.97 grams of methyltrimethoxysilane with 0.8 gram of water
Step 2) Mixing: mix 300 grams of CEX1, 9.7 grams of water, and the methyltrimethoxysilane solution prepared from Step 1) in an industrial blender
Step 3) Heating: heating the mixture prepared from Step 2) at 350° C. for 6 hours under a flow of oxygen gas to produce EX3.2 comprising around 2000 ppm of Si.
EX3.3 was prepared according to the same method as EX3.2, except that 8.25 grams ethanol is used instead of water in Step 2).
EX3.4 was prepared according to the same method as EX3.2, except that 0.30 gram of methyltrimethoxysilane is mixed with 0.05 gram of water in Step 1 and 11.1 grams ethanol is used in Step 2) instead of water. EX3.4 comprising around 200 ppm of Si.
EX3.5 was prepared according to the same method as EX3.3, except that 0.74 gram of methyltrimethoxysilane is mixed with 0.20 gram of water in Step 1 and 10.6 grams ethanol is used in Step 2) instead of water. EX3.5 comprising around 500 ppm of Si.
EX3.6 was prepared according to the same method as EX3.3, except that 1.48 gram of methyltrimethoxysilane is mixed with 0.39 gram of water in Step 1 and 9.8 grams ethanol is used in Step 2) instead of water. EX3.6 comprising around 1000 ppm of Si.

TABLE 2
Summary of the process and properties of CEX1, EX1.1-
EX1.3, EX2.1-EX2.3, CEX2.1-CEX2.4, and CEX3.1-CEX3.3

| | | | Si | | Carbon (ppm) | | | | | |
|---|---|---|---|---|---|---|---|---|---|---|
| | | | amount | Heating | Before | After | XPS | | Si_{B}/ | Q total |
| ID | Morphology | Si source | (ppm) | (° C.) | exposure | exposure | Si_{C} | SI_{B} | Si_{A} | (mAh/g) |
| CEX1 | Single- | n.a | n.a | n.a | 195 | 1265 | 0 | 0 | — | 68.8 |
| EX1.1 | crystalline | PDMS-C | 2000 | 75 | 543 | 1472 | 0.27 | 0.21 | 21.9 | 47.6 |
| EX1.2 | | PDMS-C | 2000 | 150 | 371 | 1233 | 0.30 | 0.23 | 24.3 | 44.2 |
| EX1.3 | | PDMS-C | 2000 | 300 | 302 | 1258 | 0.27 | 0.22 | 22.5 | 36.5 |
| EX2.1 | | PDMS-O | 2000 | 75 | 1625 | n.a | 29.12 | 0.97 | 101.0 | 49.4 |
| EX2.2 | | PDMS-O | 2000 | 150 | 1416 | n.a | 12.33 | 0.92 | 96.6 | 46.6 |
| EX2.3 | | PDMS-O | 2000 | 300 | 222 | n.a | 0.60 | 0.38 | 39.4 | 38.2 |
| CEX2.1 | Poly- | n.a | n.a | n.a | 511 | 3809 | 0 | 0 | — | 89.8 |
| CEX2.2 | crystalline | PDMS-C | 2000 | 75 | 959 | 2624 | 0.35 | 0.26 | 27.1 | 91.7 |
| CEX2.3 | | PDMS-C | 2000 | 150 | 679 | 2493 | 0.29 | 0.23 | 23.5 | 72.3 |
| CEX2.4 | | PDMS-C | 2000 | 300 | 804 | 2761 | 0.24 | 0.19 | 20.3 | 74.5 |
| CEX3.1 | | PDMS-O | 2000 | 75 | 1644 | n.a | 2.40 | 0.71 | 73.7 | 80.7 |
| CEX3.2 | | PDMS-O | 2000 | 150 | 1885 | n.a | 2.61 | 0.72 | 75.5 | 71.6 |
| CEX3.3 | | PDMS-O | 2000 | 300 | 695 | n.a | 0.25 | 0.20 | 21.0 | 47.3 |

n.a = not available

TABLE 3
Summary of the process and properties of CEX1 and EX3.1-EX3.6

| | | | | | | | | | | | Sulfide | Polymer |
|---|---|---|---|---|---|---|---|---|---|---|---|---|
| | | Si | | Moisture (ppm) | | Carbon (ppm) | | | | | cell | cell |
| | | amount | | Before | After | Before | After | XPS | | Si_{B}/ | EF | Q |
| ID | Si source | (ppm) | Solvent | exposure | exposure | exposure | exposure | Si_{C} | Si_{B} | Si_{A} | (%) | total |
| CEX1 | (CH₃Si(OCH₃)₃) | n.a | n.a | 170 | 1415 | 195 | 1265 | 0 | 0 | — | 84.7 | 68.8 |
| EX3.1 | (CH₃Si(OCH₃)₃) | 2000 | — | n.a | n.a | 163 | n.a | n.a | n.a | n.a | 89.3 | n.a |
| EX3.2 | (CH₃Si(OCH₃)₃) | 2000 | H₂O | 115 | 460 | 814 | 962 | 5.34 | 0.84 | 88.0 | 86.1 | n.a |
| EX3.3 | (CH₃Si(OCH₃)₃) | 2000 | H₂O | 59 | 451 | 628 | 815 | 4.97 | 0.83 | 87.0 | 86.3 | 42.9 |
| EX3.4 | (CH₃Si(OCH₃)₃) | 2000 | H₂O | n.a | n.a | 173 | n.a | n.a | n.a | n.a | 88.0 | n.a |
| EX3.5 | (CH₃Si(OCH₃)₃) | 200 | H₂O | n.a | n.a | 223 | n.a | n.a | n.a | n.a | 87.2 | 43.8 |
| EX3.6 | (CH₃Si(OCH₃)₃) | 500 | H₂O | n.a | n.a | 363 | n.a | n.a | n.a | n.a | 87.5 | 43.2 |

n.a = not available

Table 2 and Table 3 summarizes the process and properties of examples and comparative examples with variation in the morphology, Si source, Si amount, and heating temperature. In the XPS analysis, Si_{B} or Si_{C} value higher than 0 indicates that Si is present on the surface of the positive electrode active material as associated with the XPS measurement which signal is acquired from the first few nanometers (e.g. 1 nm to 10 nm) of the uppermost part of a sample, i.e. surface layer.

From Table 2, it could be observed that positive electrode active material having a combination of single-crystalline morphology (i.e. having single particles and/or secondary particles, wherein each of the single particles consist of only one primary particle and each of the secondary particles consist of at least two primary particles and at most twenty primary particles) and Si on the surface can suppress the leaked capacity (Qₜₒₜₐₗ) better in comparison with the positive electrode active material with polycrystalline morphology. Moreover, a lower carbon level after 3 days exposure test is observed for the positive electrode active material comprising single-crystalline morphology and Si on the surface.

In Table 3, all the morphology of positive electrode active material is single-crystalline and methyltrimethoxysilane is used as the source of Si. Further benefit is observed in a lower moisture level after 3 days exposure test and an improved efficiency in the sulfide cell.

1-15. (canceled)

16. A positive electrode active material for solid state batteries, comprising lithium, oxygen, nickel, and at least one metal selected from the group consisting of manganese and cobalt, wherein said positive electrode active material further comprises silicon in a content Si_{B}, wherein Si_{B} is expressed as molar fraction Si compared to the sum of molar fractions of Ni, Mn, Co, and Si, as measured by XPS analysis,
wherein Si_{B}>0.05, and
wherein the positive electrode active material comprises single-crystalline particles.

17. The positive electrode active material according to claim 16, further comprising a carbon content in the range of 150 ppm and 2000 ppm by total weight of the positive electrode active material, as determined by a carbon analyzer.

18. The positive electrode active material according to claim 16, wherein Si_{B} is in the range of 0.1 and 1.0.

19. The positive electrode active material according to claim 16, wherein said positive electrode active material further comprises silicon in a content Si_{C}, wherein Si_{C} is expressed as molar fraction Si compared to the sum of molar fractions of Ni, Mn and Co, as measured by XPS analysis, wherein Si_{C} is in the range of 0.10 and 50.0.

20. The positive electrode active material according to claim 16, comprising Li, Ni, Mn, Co and oxygen, wherein:
Ni in a content x, wherein 50.0≤x≤98.0 mol %, relative to the sum of Ni, Mn and Co,
Mn in a content y, wherein 0.0≤y≤30.0 mol %, relative to the sum of Ni, Mn and Co,
Co in a content z, wherein 0.0≤z≤30.0 mol %, relative to the sum of Ni, Mn and Co,
wherein x, y and z are measured by ICP-OES.

21. The positive electrode active material according to claim 20, comprising Li, M′, and oxygen, wherein M′ comprises:
Ni in a content x′, wherein 50.0≤x′≤98.0 mol %, relative to M′,
Mn in a content y′, wherein 0.0≤y′≤30.0 mol %, relative to M′,
Co in a content z′, wherein 0.0≤z′≤30.0 mol %, relative to M′,
Si in a content a′, wherein 0.0<a′≤5.0 mol %, relative to M′,
D in a content d′, wherein D is an element other than Li, Ni, Mn, Co, Si and oxygen;
wherein 0.0≤d′≤2.0 mol %, relative to M′,
wherein x′, y′, z′, a′ and d′ are measured by ICP-OES, and
wherein x′+y′+z′+a′ is 100.0 mol %.

22. The positive electrode active material according to claim 21, wherein the positive electrode active material has a Si content Si_{A} defined as a′/(x′+y′+z′+a′), wherein the ratio Si_{B}/Si_{A}>5.0.

23. The positive electrode active material according to claim 22, wherein the ratio Si_{B}/Si_{A}>10.0.

24. The positive electrode active material according to claim 21, wherein 55.0 mol %≤x′≤90.0 mol %, relative to M′.

25. The positive electrode active material according to claim 16 having a carbon uptake of less than 1500 ppm carbon by total weight of the positive electrode active material, wherein the carbon uptake is measured by an exposure test.

26. A method for manufacturing a positive electrode active material, wherein said method comprises:
step a) mixing a lithium transition metal-based oxide compound with a source of silicon, and
step b) heating the mixture under an oxidizing atmosphere in a furnace at a temperature under 500° C. for a time between 1 hour and 20 hours so as to obtain the positive electrode active material.

27. The method according to claim 26, wherein the source of Si is a Si-alkoxide, an alkylalkoxy silane or a polysiloxane.

28. A solid-state battery comprising the positive electrode active material according to claim 16.

29. The solid-state battery according to claim 28, comprising a polymer-based solid electrolyte or a sulfide-based solid electrolyte.

30. A portable computer, a tablet, a mobile phone, an energy storage system, an electric vehicle, or a hybrid electric vehicle comprising the solid-state battery according to claim 29.
